(19) United States
(12) Patent Application Publication
(10) Pub. No.: US 2024/0087282 A1
(43) Pub. Date: Mar. 14, 2024

(54) ASSISTED SECONDARY REDACTION OF REFLECTED IMAGES

(71) Applicant: MOTOROLA SOLUTIONS, INC., Chicago, IL (US)

(72) Inventors: Luke Young, Temecula, CA (US); Juan Felipe Gonzalez-Gomez, Sterrett, AL (US); Alexander Saputa, Hoover, AL (US)

(21) Appl. No.: 17/930,983

(22) Filed: Sep. 9, 2022

(51) Int. Cl. G06V 10/60; G06T 5/00; G06T 7/13; G06T 7/70; G06V 10/25; G06V 20/52

(52) U.S. Cl. CPC G06V 10/60; G06T 5/005; G06T 7/13; G06T 7/70; G06V 10/25; G06V 20/52; G06V 2201/07

(57) ABSTRACT

One aspect provides a video surveillance system including a video camera configured to capture a video and a video redactor in communication with the video camera and including an electronic processor. The electronic processor is configured to retrieve the video from the video camera, identify an object to be redacted from the video, and redact the object from the video. The electronic processor is further configured to identify a first reflective surface appearing in the video, redact the first reflective surface from the video, and output a modified video in which the object and the first reflective surface have been redacted.

### BACKGROUND OF THE INVENTION

The disclosure relates to digital redaction tools used for redacting sensitive information, such as objects and text, from images and videos.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments, examples, aspects, and features that include the claimed subject matter, and explain various principles and advantages of those embodiments, examples, aspects, and features.

FIG. 1 is a block diagram of a video surveillance system in accordance with some aspects.

FIG. 2 is a marked-up frame of a video captured by the video surveillance system of FIG. 1 in accordance with some aspects.

FIG. 3 is an example video file mapped to and analyzed in three-dimensional space by the video surveillance system of FIG. 1 in accordance with some aspects.

FIG. 4 is a flowchart of an example method for video redaction performed by the video surveillance system of FIG. 1 in accordance with some aspects.

FIG. 5 is a flowchart of an example method for video redaction performed by the video surveillance system of FIG. 1 in accordance with some aspects.

FIG. 6 is a flowchart of another example method for video redaction performed by the video surveillance system of FIG. 1 in accordance with some aspects.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments, examples, aspects, and features.

The apparatus and method components have been represented where appropriate by conventional symbols in the drawings, showing only those specific details that are pertinent to understanding various embodiments, examples, aspects, and features so as not to obscure the disclosure with details that will be readily apparent to those of ordinary skill in the art having the benefit of the description herein.

### DETAILED DESCRIPTION OF THE INVENTION

Digital redaction tools are used to assist with the redaction of identifying information from images and videos. However, such digital redaction tools are deficient in detecting and redacting reflections of a redacted object appearing in an image or video. For example, digital redaction tools that assist users with detecting and redacting a face from a video fail to also detect and redact reflections of the redacted face that appear in the video. Although users can manually detect and redact reflections of redacted objects from video, this process is time consuming and often inaccurate. Thus, there is a need for a digital redaction tool that assists with the redaction of reflected images.

One aspect provides a video redactor including an electronic processor configured to retrieve a video, identify a object to be redacted from the video, and redact the object from the video. The electronic processor is further configured to identify a first reflective surface appearing in the video, redact the first reflective surface from the video, and output a modified video in which the object and the first reflective surface have been redacted.

Another aspect provides a method for video redaction including identifying, using the electronic processor, an object to be redacted from the video and redacting, using the electronic processor, the object from the video. The method further includes identifying, using the electronic processor, a first reflective surface appearing in the video,
redacting, using the electronic processor, the first reflective surface appearing in the video, and outputting, using the electronic processor, a modified video in which the object and the first reflective surface have been redacted.

Another aspect provides a video surveillance system including a video camera configured to capture a video and a video redactor in communication with the video camera and including an electronic processor. The electronic processor is configured to retrieve the video, identify an object to be redacted from the video, and redact the object from the video. The electronic processor is further configured to identify a first reflective surface appearing in the video, redact the first reflective surface from the video, and output a modified video in which the object and the first reflective surface have been redacted.

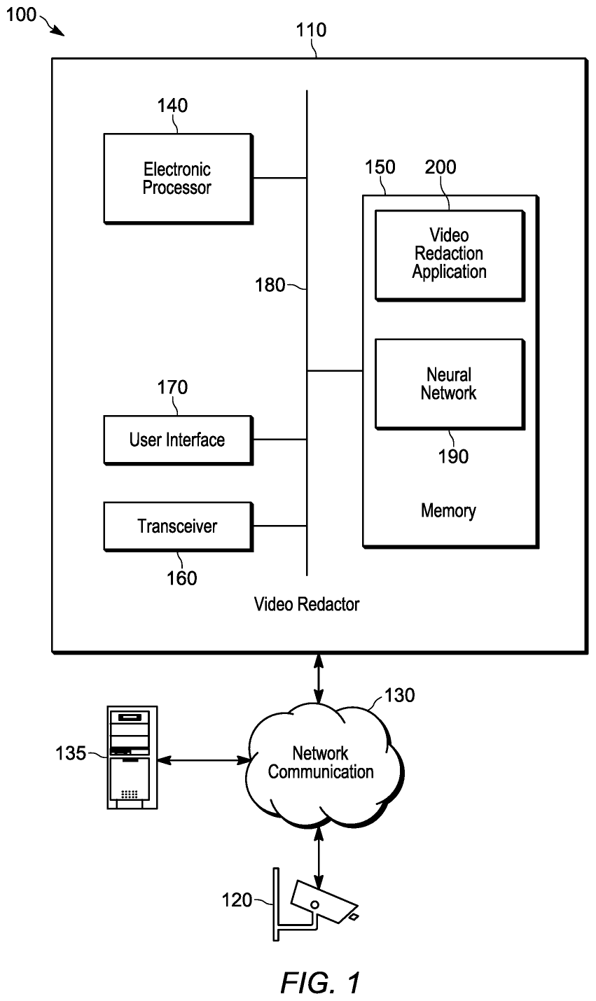

FIG. 1 is a block diagram of an example video surveillance system 100. In the example illustrated, the video surveillance system 100 includes a video redaction computer, which in one example is a video redactor 110, communicating with a video camera 120 over a communication network 130. FIG. 1 illustrates a single video camera 120 as an example. However, the video surveillance system 100 may include a plurality of video cameras 120 communicating with one or more video redactors 110.

In some instances, the video redactor 110 and the video camera 120 are separate devices, for example, a surveillance computer communicating with a surveillance camera. In such instances, the communication network 130 is a wired or wireless communication network including, for example, a cellular network, the Internet, a local area network, a wide area network, a private network, and the like.

In some instances, the video redactor 110 may not retrieve a video directly from the video camera 120. In such instances, the video redactor 110 may analyze a pre-recorded video, such as a video captured by the video camera 120, that is stored in a network storage device 135. As shown in FIG. 1, the network storage device 135 communicates with the video redactor 110 and the video camera 120 over the communication network 130. Accordingly, in such instances, the video camera 120 sends, via the communication network 130, a captured video for storage in the network storage device 135 and the video redactor 110 retrieves, via the communication network 130, the video from the network storage device 135. In some instances, the network storage device 135 is implemented as one or more of a database, a local server, a remote server, cloud storage, and/or hybrid cloud storage.

In other instances, the video redactor 110 and the video camera 120 are part of the same device, for example, a surveillance camera. In such instances, the communication network 130 may not be needed or may include a wired connection for providing the captured video from the video camera 120 to the video redactor 110. The video redactor 110 could be implemented as a video redaction server, a video redaction engine, a video redaction module, a video redaction device, a cloud-based video redaction engine, or the like.

In the example illustrated, the video redactor 110 includes an electronic processor 140, a memory 150, a transceiver 160, and a user interface 170. The electronic processor 140, the memory 150, the transceiver 160, and the user interface 170 communicate over one or more control and/or data buses (for example, a communication bus 180). FIG. 1 illustrates only one example of the video surveillance system 100. The video surveillance system 100 may include more or fewer components and may perform additional functions other than those described herein.

In some instances, the electronic processor 140 is implemented as a microprocessor with separate memory, such as the memory 150. In other instances, the electronic processor 140 is implemented as a microcontroller (with memory 150 on the same chip). In other instances, the electronic processor 140 is implemented using multiple processors. In some instances, the video redactor 110 includes one electronic processor 140 and/or a plurality of electronic processors 140, for example, in a cluster arrangement, one or more of which may be executing none, all or a portion of the applications of the video redactor 110 described below, sequentially or in parallel across the one or more electronic processors 140. The one or more electronic processors 140 comprising the video redactor 110 may be geographically co-located or may be geographically separated and interconnected via electrical and/or optical interconnects. One or more proxy servers or load balancing servers may control which one or more electronic processors 140 perform any part or all of the applications described below.

In the example illustrated, the memory 150 includes non-transitory, computer-readable memory that stores instructions that are received and executed by the electronic processor 140 to carry out the functionality of the video redactor 110 described herein. The memory 150 includes, for example, a program storage area and a data storage area. The program storage area and the data storage area may include combinations of different types of memory, such as read-only memory and random-access memory. In some instances, the memory 150 includes one or more databases for organized storage of videos and respective video metadata.

The transceiver 160 enables wired and/or wireless communication between the video redactor 110 and other devices (for example, the video camera 120). In some instances, the transceiver 160 comprises separate transmitting and receiving components. The user interface 170 includes one or more input mechanisms (for example, a keyboard, a mouse, and the like), one or more output mechanisms (for example, a display, a speaker, and the like), and/or a combination input/output mechanism (for example, a touch-screen display). For example, the user interface 170 displays a video captured by the video camera 120 to a user. As another example, the user interface 170 receives a user input that selects which objects appearing in the video should be redacted.

In the example illustrated, the memory 150 includes an artificial intelligence (AI) module, such as a neural network 190, that loosely mimics operation of the neurons in an animal brain. In some examples, the neural network 190 is a convolutional neural network that is specifically designed for analyzing visual imagery such as images and videos. In other examples, the neural network 190 is implemented as another type of neural network, such a recurrent neural network, feed forward neural network, multilayer perceptron neural network, etc. Furthermore, in the example illustrated, a video redaction application 200 is stored in the memory 150. As will be described in more detail below, the video redaction application 200 is executed by the electronic processor 140 to identify and selectively redact objects, reflections of objects, and/or reflective surfaces that appear in image and/or video files. Hereinafter, image and/or video files captured by the video camera 120 and processed by the video redactor 110 will simply be referred to as “videos” and/or “video files” for the sake of brevity. However, it should be understood that methods described herein for analyzing and/or redacting videos are also applicable to images.

In some instances, the video redaction application 200 is implemented in the video surveillance system 100 without using neural networks or other artificial intelligence techniques. In such instances, the video redaction application 200 includes logic (for example, procedural programming or object-oriented programming) to identify and selectively redact objects, reflections of objects, and/or reflective surfaces that appear in image and/or video files. In some instances, the video redaction application 200 is part of a Video Management System (VMS) such as, for example, a commercially available VMS like Avigilon Control Center.

In some instances, the video redaction application 200 is implemented using AI techniques, such as machine learning and/or the neural network 190. In such instances, the video redaction application 200 may include a prediction model and/or an objection detection model that is trained to detect the presence of objects, reflections of objects, and/or reflective surfaces that reveal identifying information prior to deployment in the video surveillance system 100, Some non-limiting examples of objects that reveal identifying information include physical features associated with a person, such as faces, hair, hands, tattoos, scars, birthmarks, gang symbols, and other physical characteristics that can be used to identify a person. Other non-limiting examples of objects that reveal identifying information include objects other than physical features associated with a person, such as name tags, license plates, phone numbers, automobiles, addresses, employment identification, banking information, text messages, electronic mail, and the like. Some non-limiting examples of reflective surfaces that may reflect objects that reveal identifying information include windows, mirrors, display screens, glass frames, countertops, shiny floors, bodies of water and/or other liquids, metal surfaces, and the like. In some instances, the video redaction application 200 is further trained to determine whether detected objects, whether appearing in the frame of the video or moved out of the frame of the video, are reflected by detected reflective surfaces. It should be understood that determining whether an object is reflected by a reflective surface includes determining whether the entire object is reflected by a reflective surface as well as determining whether only a portion of the object is reflected by a reflective surface.

During training, video files including objects that reveal identifying information, partial and/or whole reflections of objects that reveal identifying information, and/or reflective surfaces are provided as inputs to the video redaction application 200. In some instances, the training video files are pre-marked with the locations and classes of objects, object reflections, and/or reflective surfaces appearing in the video files. In such instances, the video redaction application 200 is trained to detect and identify classes of objects, reflections of objects, and/or reflective surfaces that are similar to the ones appearing in the pre-marked training video files. In other instances, training the video redaction application 200 includes providing video files that are not pre-marked with the locations and classes of objects, object reflections, and/or reflective surfaces as inputs to the video redaction application 200. In such instances, the video redaction application 200 generates a prediction based on the training video file that was provided as an input. The prediction includes locations in the video where the video redaction application 200 has detected one or more of an object to be redacted from the video, whole and/or partial reflections of the object to be redacted from the video, and reflective surfaces appearing in the video and/or to be redacted from the video. In some instances, the video redaction application 200 is trained using techniques other than those described herein. After training is complete, the video redaction application 200 is deployed for use in the video surveillance system 100.

In operation, the electronic processor 140 executes the video redaction application 200 to redact objects, reflections of the redacted objects, and/or reflective surfaces from videos captured by the video camera 120. As will be described in more detail below, the video redaction application 200 assigns respective confidence scores to each of the objects, reflections of the objects, and/or reflective surfaces that are detected to appear in a video. A confidence score is a number (for example, a decimal or percentage) that indicates how confident the video redaction application 200 is that a detected object, a detected reflection of an object, and/or a detected reflective surface risks revealing identifying information that should be redacted from the video. For example, the confidence score for a detected reflective surface indicates a likelihood of the detected reflective surface reflecting at least a portion of a detected object, wherein the at least reflected portion risks revealing identifying information. As another example, the confidence score for a detected object reflection is a number that indicates how confident the video redaction application 200 is that at least a portion of the object reflection risks revealing identifying information. As another example, the confidence score for a detected object is a number that indicates how confident the video redaction application 200 is that the detected object risks revealing identifying information.

Detected objects, object reflections, and/or reflective surfaces for which the video redaction application 200 is confident reveal identifying information are assigned relatively high confidence scores (e.g., greater than 50%). Some non-limiting examples of a detected object to which the video redaction application 200 might assign a high confidence score include a person's face with clearly visible features, a tattoo, a name tag, a credit card, etc. Some non-limiting examples of a detected reflective surface to which the video redaction application 200 might assign a high confidence score include a display screen of a smartphone that is held by a redacted person, a mirror proximate a person that is redacted from the video, a countertop disposed between a redacted person and the video camera 120 that captured the video, etc. Some non-limiting examples of a reflection of a detected object to which the video redaction application 200 might assign a high confidence score include a partial reflection of a redacted face in which the reflected portion of the redacted face reveals an identifying characteristic such as a scar or tattoo, a reflection of a license plate with clearly visible numbers, etc.

In contrast, detected objects, object reflections, and/or reflective surfaces for which the video redaction application 200 is not confident reveal identifying information are assigned relatively low confidence scores (e.g., less than 50%). A non-limiting example of a detected object to which the video redaction application 200 might assign a low confidence score include the back of a person wearing a large jacket. A non-limiting example of a detected reflective surface to which the video redaction application 200 might assign a low confidence score is a window positioned across the room from a redacted object. A non-limiting example of reflection of a redacted object to which the video redaction application 200 might assign a low confidence score is a partial reflection of the back of a redacted person's head, wherein the partial reflection does not reveal any identifying characteristics.

In some instances, the video redaction application 200 determines whether to redact detected objects, object reflections, and/or reflective surfaces from a video based on comparisons between a configurable confidence score threshold (e.g., 50%) and respective confidence scores assigned to the detected objects, reflections of objects, and/or reflective surfaces. For example, the video redaction application 200 may redact the detected objects, object reflections, and/or reflective surfaces that are assigned confidence scores that exceed the confidence score threshold from the video and not redact the detected objects, object reflections, and/or reflective surfaces that are assigned confidence scores that do not exceed the confidence score threshold. In some instances, the video redaction application 200 determines whether to redact detected objects, object reflections, and/or reflective surfaces based on a plurality of confidence score thresholds and/or ranges. For example, the video redaction application 200 may redact the detected objects, object reflections, and/or reflective surfaces that are assigned confidence scores that exceed an upper confidence score threshold (e.g., 70%) from the video and not redact the detected objects, object reflections, and/or reflective surfaces that are assigned confidence scores that are less than a lower confidence score threshold (e.g., 30%). However, in such instances, the video redaction application 200 may prompt, via the user interface 170, a user to confirm whether the detected objects, object reflections, and/or reflective surfaces that are assigned confidence scores between the lower and upper confidence score thresholds (e.g., confidence scores between 30%-70%) should be redacted from the video. Accordingly, the video redaction application 200 would then redact the detected objects, object reflections, and/or reflective surfaces that the user confirms should be redacted and not redact the detected objects, object reflections, and/or reflective surfaces that the user confirms should not be redacted.

In some instances, the video redaction application 200 operates in a redact all mode in which the video redaction application 200 redacts every detected object reflection and/or reflective surface, regardless of the respective confidence scores assigned to the detected object reflections and/or reflective surfaces. In some instances, the video redaction application 200 operations in a human selection mode in which the video redaction application 200 redacts only the detected objects, object reflections, and/or reflective surfaces that are selected for redaction by a user.

In operation, the video redaction application 200 may display, via the user interface 170, a marked-up version of the video file in which the detected objects, object reflections, and/or reflective surfaces detected by the video redaction application 200 are identified with respective indicators. Non-limiting examples of indicators used to identify detected objects include outlines, colors, numbers, symbols, polygon overlays, and text.

With respect to the above example in which the video redaction application 200 prompts the user to confirm whether detected objects, object reflections, and/or reflective surfaces should be redacted, the video redaction application 200 may also identify the detected objects, object reflections, and/or reflective surfaces with indicators that correspond to their respective assigned confidence scores. For example, the video redaction application 200 may identify detected objects, object reflections, and/or reflective surfaces having confidence scores that are below the lower confidence score threshold with a first type of indicator (e.g., a red polygon overlay), identify detected objects, object reflections, and/or reflective surfaces having confidence scores that exceed the upper confidence score threshold with a second type of indicator (e.g., a green polygon overlay), and identify detected objects, object reflections, and/or reflective surfaces having confidence scores that are between the lower and upper confidence score thresholds with a third type of indicator (e.g., yellow polygon overlay).

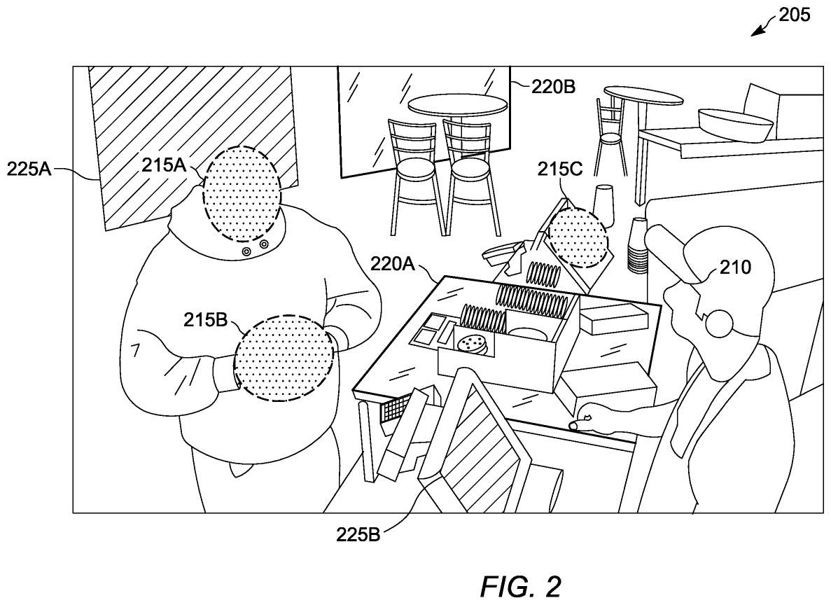

FIG. 2 illustrates an example version of a marked-up video frame 205 that is displayed to a user via the user interface 170. In the example illustrated, a first object 210 (e.g., a person's face) has already been redacted from the video frame 205. In the illustrated example, redacting the first object 210 includes obscuring the identifying features of the person's face. In some examples, the first object 210 is redacted in response to a user selection, and in other examples, the first object 210 is automatically detected and redacted by the video redaction application 200. In other examples, the first object 210 was redacted from the video before the video was provided as an input to the video redaction application 200.

The marked-up video frame 205 also includes a plurality of additional objects, object reflections, and/or reflective surfaces that have been detected and identified with respective indicators by video redaction application 200. For example, the video frame 205 includes a first group of objects, object reflections, and/or reflective surfaces that are identified with first-type indicators 215A-215C (e.g., oval overlays filled in with dots) to indicate that each of the first group of objects, object reflections, and/or reflective surfaces have been assigned a confidence score that exceeds the upper confidence score threshold. The video redaction application 200 identifies objects, object reflections, and/or reflective surfaces with the first-type indicators 215A-215C to indicate that the video redaction application 200 has determined to redact those objects, object reflections, and/or reflective surfaces. The marked-up video frame 205 further includes a second group of objects, object reflections, and/or reflective surfaces that are identified with second-type indicators 220A, 220B (e.g., outlines without any filling) to indicate that each of the second group of objects, object reflections, and/or reflective surfaces have been assigned a confidence score that is less than the lower confidence score threshold. Thus, the video redaction application 200 identifies objects, object reflections, and/or reflective surfaces with the second-type indicators 220A-220B to indicate that the video redaction application 200 has determined not to redact those objects, object reflections, and/or reflective surfaces from the video.

Furthermore, the marked-up video frame 205 includes a third group of objects, object reflections, and/or reflective surfaces that are identified with third-type indicators 225A, 225B (e.g., outlines filled in with diagonal lines) to indicate that each of the third group of objects, object reflections, and/or reflective surfaces have been assigned a confidence score that is between the upper and lower confidence score thresholds. The video redaction application 200 identifies objects, object reflections, and/or reflective surfaces with the third-type indicators 225A, 225B to indicate that the video redaction application 200 is not sure as to whether those objects, object reflections, and/or reflective surfaces should be redacted from the video. Accordingly, the video redaction application 200 then prompts a user to select whether the objects, object reflections, and/or reflective surfaces identified with the third-type indicators 225A, 225B should be redacted from the video.

As described above, in some instances, the video redaction application 200 is operable to receive, via the user interface 170, user selections of objects that are to be redacted from an image and/or video. For example, the video redaction application 200 prompts, via the user interface 170, to select an object to be redacted from the video. In some instances, the video redaction application 200 implements one or more computer vision and/or image processing techniques to automatically detect objects appearing in a video that should be redacted. In other instances, a video in which objects have already been redacted is provided as input to the video redaction application 200. In such instances, the video redaction application 200 analyzes the video to detect and redact reflections of the previously redacted objects. An object, whether selected by a user or automatically detected by the video redaction application 200, that is to be redacted from a video may be referred to as “a redacted object.”

In operation, the video redaction application 200 implements one or more computer vision and other image processing techniques to automatically detect candidate reflective surfaces appearing in the video that might reflect a redacted object. In some instances, the video redaction application 200 implements computer vision techniques to identify models appearing in the video that match common reflective surfaces, such as but not limited to windows, mirrors, display screens, glass frames, countertops, shiny floors, bodies of water and/or other liquids, metal surfaces, and the like. In some instances, the video redaction application 200 leverages object geometries to detect the presence of candidate reflective surfaces in the video. Since reflective surfaces, such as countertops, windows, display screens, and splash guards, often have a quadrilateral shape, the video redaction application 200 uses edge detection algorithms to detect the edges of the quadrilateral surfaces appearing in the video to identify candidate reflective surfaces. Accordingly, in some instances, the video redaction application 200 defines quadrilateral outlines, or boundaries, for all candidate reflective surfaces detected in the video.

In addition to simply identifying candidate reflective surfaces that appear in a video, the video redaction application 200 further uses various computer vision and/or image processing techniques to determine whether a redacted object is reflected by any of the candidate reflective surfaces appearing in the video. It should be understood that determining whether a redacted object is reflected by a candidate reflective surface includes determining whether the entire redacted object is reflected by the candidate reflective surface as well as determining whether only a portion of the redacted object is reflected by the candidate reflective surface.

In some instances, the video redaction application 200 uses image processing techniques to analyze the values of pixels and/or image data associated with a redacted object and the pixels and/or image data located within an identified outline, or boundary, of a candidate reflective surface. For example, the video redaction application 200 identifies correlations between spectral patterns, simultaneous movements, image velocities, and/or other features associated with the pixels and/or image data disposed within the identified outline of the candidate reflective surface and the pixels and/or image data comprising the redacted object. In some instances, the video redaction application 200 determines a confidence score for the candidate reflective surface based on the comparisons between the pixels and/or image data disposed within the outline of the candidate reflective surface and the pixels and/or image data associated with the redacted object. For example, the video redaction application 200 might assign a high confidence score to a candidate reflective surface upon determining that the reflected object or partial reflection associated with an identifying feature of the redacted object moves substantially simultaneously and/or with a similar velocity as the object moving within the outline of the candidate reflective surface. The image data associated with a redacted object and/or the image data located within an identified outline of a candidate reflective surface may also be referred to as the feature set of a redacted object and/or the feature set a candidate reflective surface.

In some examples, the video redaction application 200 assigns a high confidence score to a candidate reflective surface upon determining that the spectral pattern of image data within the identified outline of the candidate reflective surface has a high cross-correlation with a spectral pattern of image data that is associated with the redacted object. In some examples, the video redaction application 200 assigns a relatively high confidence score to the candidate reflective surface when the pixel value comparison indicates that identifying information (e.g., birthmarks, tattoos, facial features, etc.) associated with the redacted object is partially or fully reflected by the candidate reflective surface. In some examples, the video redaction application 200 assigns a relatively low confidence score to the candidate reflective surface when the pixel value comparison indicates that no portion of the redacted object, or only a portion of the redacted object that does not reveal identifying information (e.g., birthmarks, tattoos, facial features, etc.) associated with the redacted object, is reflected by the candidate reflective surface.

In some instances, the video redaction application 200 determines whether a candidate reflective surface reflects identifying information associated with a redacted object based on the relative spatial geometries of the candidate reflective surface, the redacted object, the field of view (FOV) of the video camera 120 that captured the video, and/or other objects appearing in the video. In such examples, the video redaction application 200 uses computer vision and/or image processing techniques, such as augmented reality processing techniques, to map the two-dimensional (2-D) video scene to three-dimensional (3-D) space. After mapping the 2-D video scene to 3-D space, the video redaction application 200 establishes a planar normal to the candidate reflective surface. For example, the planar normal may be determined based on the identified outline of the candidate reflective surface and/or the spectral patterns of image data occurring within the identified outline of the candidate reflective surface. Furthermore, the video redaction application 200 determines relative distances, angles, and/or other geometric relationships between the redacted object, the candidate reflective surface, the video camera 120, and other objects mapped to 3-D space. The video redaction application 200 then determines whether the candidate reflective surface reflects identifying features of the redacted object based on the above described spatial geometries. For example, the video redaction application 200 may assign a high confidence score to the candidate reflective surface if the relative angles between the redacted object, the planar normal to the reflective surface, and the video camera 120 indicate that the redacted object is reflected by the reflective surface within the FOV of the video camera 120.

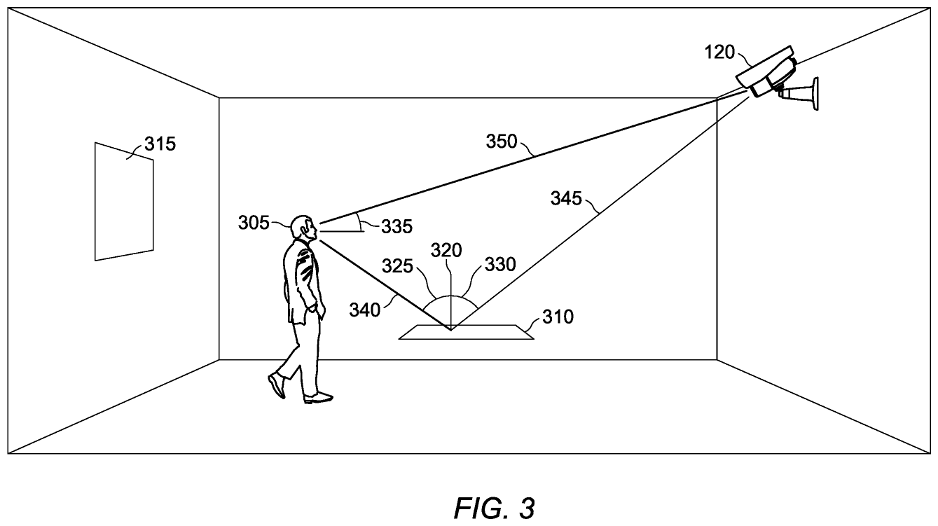

FIG. 3 illustrates an example 2-D video scene that the video redaction application 200 has mapped to 3-D space. The mapped, or extrapolated, video scene includes, among other things, the video camera 120 that captured the video scene, a redacted person 305, a first candidate reflective surface 310, and a second candidate reflective surface 315. In the example illustrated, the first candidate reflective surface 310 is a reflective table positioned between the redacted person 305 and the video camera 120. The second candidate reflective surface 315 is a reflective window disposed behind the redacted person 305.

The video redaction application 200 determines a planar normal 320 to the first candidate reflective surface 310. In addition, the video redaction application 200 determines a first angle 325 between the redacted person 305 and the planar normal 320, a second angle 330 between the planar normal 320 and the video camera 120, and a third angle 335 between the redacted person 305 and the video camera 120. Moreover, the video redaction application 200 determines a first distance 340 between the redacted person 305 and the first candidate reflective surface 310, a second distance 345 between the video camera 120 and the first candidate reflective surface 310, and a third distance 350 between the redacted person 305 and the video camera 120. Based on one or more of the determined planar normal 320, the determined angles 325, 330, 335, and/or the determined distances 340, 345, 350, the video redaction application 200 determines the likelihood of the first candidate reflective surface 310 reflecting identifying features of the redacted person 305 within the FOV of the video camera 120. If, based on the determined spatial geometry relationships between the video camera 120, the redacted person 305, and/or the first candidate reflective surface 310, the video redaction application 200 determines that the first candidate reflective surface 310 likely reflects identifying features associated with the redacted person 305, the video redaction application 200 assigns a high confidence score to the first candidate reflective surface 310. However, if the video redaction application 200 determines that the first candidate reflective surface 310 likely does not reflect identifying features associated with the redacted person 305 based on the determined spatial geometry relationships between the video camera 120, the redacted person 305, and/or the first candidate reflective surface 310, the video redaction application 200 assigns a low confidence score to the first candidate reflective surface 310.

Still referring to the example illustrated in FIG. 3, the video redaction application 200 may also determine a planar normal to the second candidate reflective surface 315 and various spatial geometry relationships between the video camera 120, the redacted person 305, and the second candidate reflective surface 315. Since the second candidate reflective surface 315 is behind the redacted person 305 and further away from the video camera 120 than the first candidate reflective surface 310 in the illustrated example, the second candidate reflective surface 315 seems less likely to reflect identifying features of the redacted person 305 within the FOV of video camera 120 than the first candidate reflective surface 310. Accordingly, in the illustrated example, the video redaction application 200 might assign a lower confidence score to the second candidate reflective surface 315 than the first candidate reflective surface 310 after analyzing the spatial geometry relationships between the video camera 120, the redacted person 305, the first candidate reflective surface 310, and the second candidate reflective surface 315.

In some instances, a special case of reflected movement that is detected by the video redaction application 200 occurs when a curved mirror surface appears in the video. In such cases, the velocity of a source image appears as an accelerated velocity (e.g., faster) in the reflection of the source image in the curved surface. Accordingly, the video redaction application 200 detects a difference between the velocity of a source image, such as a redacted object, and the velocity of the reflection of the redacted object appearing in the curved mirrored surface and then maps the curvature of the mirrored surface based on the detected velocity difference. After mapping the curvature of the mirrored surface, the video redaction application 200 can more accurately determine the location of the redacted object reflection within the outline of the curved mirror surface.

In some instances, the video redaction application 200 uses the computer vision and/or image processing techniques described herein to detect and redact instances of recursive reflections appearing a video. That is, by implementing one or more of the techniques described above, such as detecting correlations between spectral patterns of a redacted object and a spatially-distance reflected surface, detecting substantially simultaneous movements of a redacted object and movements of image data within an identified outline of a detected reflective surface, or analyzing spatial geometry relationships between redacted objects and detected reflective surface, the video redaction application 200 is operable to detect whether a redacted object determined to be reflected by a first reflective surface appearing in the video is recursively reflected by a second reflective surface appearing in the video. As an example, upon determining that identifying features of a redacted object are reflected by a first reflective surface, the video redaction application 200 is operable to further determine whether the reflection of the identifying features of the redacted objected is reflected by a second reflective surface using the computer vision and/or image processing techniques described herein. Accordingly, in such instances, the video redaction application 200 also considers the likelihood of a candidate reflective surface recursively reflecting identifying information associated with a redacted object when determining a confidence score for the candidate reflective surface.

By using the computer vision and image processing techniques described above, the video redaction application 200 is operable to accurately detect and redact reflective surfaces that reflect redacted objects without using facial recognition algorithms, license plate recognition algorithms, or optical character recognition algorithms. For example, by implementing techniques such as detecting correlations between spectral patterns of a redacted object and a spatially-distance reflected surface, detecting substantially simultaneous movements of a redacted object and movements of image data within an identified outline of a detected reflective surface, analyzing spatial geometry relationships between redacted objects and detected reflective surface, and other techniques described herein, the video redaction application 200 can accurately identify and redact instances of redacted objects being reflected by reflective surfaces appearing in a video without using facial recognition algorithms, license plate recognition algorithms, or optical character recognition algorithms.

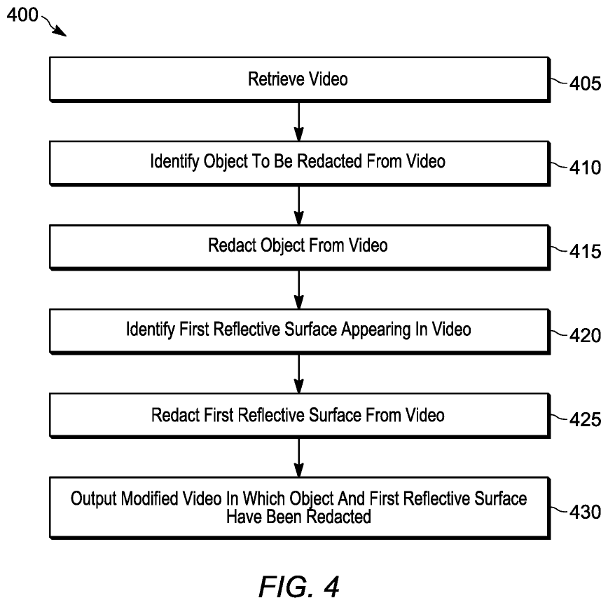

FIG. 4 illustrates a flowchart of a first example method 400 for redacting a video performed by one or more components, such as the video redactor 110 and/or the video camera 120, included in the video surveillance system 100. It should be understood that although a particular order of processing steps is indicated in FIG. 4 as an example, timing and ordering of such steps may vary where appropriate without negating the purpose and advantages of the examples set forth in detail throughout this disclosure. In the example illustrated, the method 400 begins with retrieving a video (at block 405). In some examples, the video redactor 110 retrieves the video from the video camera 120, which captures the video in a surveillance area and provides the video to the video redactor 110 over the communication network 130. In other examples, the video redactor 110 retrieves the video from the network storage device 135. As described above with respect to this example, the video camera 120 captures and stores the video in the network storage device 135, which may be implemented as one or more of a database, a local server, a remote server, cloud storage, and/or hybrid cloud storage. In other examples, the video redactor 110 and the video camera 120 are parts in a single device, and thus, the video redactor 110 retrieves the video directly from the video camera 120 without the use of communication network 130.

After retrieving the video, the electronic processor 140 identifies an object appearing in the video that is to be redacted (at block 410). As described above, in some instances, the electronic processor 140 identifies the object to be redacted from the video based on one or more user inputs or selections provided to the user interface 170. In other instances, the electronic processor 140 automatically identifies the object to be redacted from the video by using one or more computer vision and/or image processing techniques. After identifying the object to be redacted from the video, the electronic processor 140 redacts the object from the video (at block 415). In some instances, redacting the object from the video includes applying a blurred effect over the object such that blurred identifying features of the object are obscured. In other instances, redacting the object from the video includes overlaying the object with a solid block that covers the object in the video. As described above, in some instances, the object is already redacted from the video before the electronic processor 140 retrieves the video at block 405.

The method 400 also includes identifying, by the electronic processor 140, a first reflective surface appearing in the video (at block 420). As described above, in some instances, the electronic processor 140 identifies the first reflective surface by using one or more computer vision and/or image processing techniques, such as edge detection algorithms, described herein. In other instances, the electronic processor 140 identifies the first reflective surface based on one or more user inputs provided to the user interface 170. After identifying the first reflective surface, the electronic processor 140 redacts the first reflective surface from the video (at block 425). In some instances, redacting the first reflective surface from the video includes applying a blurred effect over the first reflective surface such that any identifying features of the object that might be reflected by the first reflective surface are obscured. In other instances, redacting the first reflective surface from the video includes overlaying the object with a solid block that covers up the first reflective surface.

In some instances, the electronic processor 140 redacts the first reflective surface for the entire duration of the video. In some instances, the electronic processor 140 redacts the first reflective surface only during times for which the object and the first reflective surface appear in the video at substantially the same time. In some instances, the electronic processor 140 redacts the first reflective surface from the video for a first period of time before the object appears in the video, a second period of time after the object exits the video, and for the entire duration of time for which the object appears in the video. In some instances, the electronic processor 140 redacts the first reflective surface from the video when the first reflective surface appears in the video during a first time period and the object appears in the video during a second time period, the first and second times periods being different. After redacting the object and the first reflective surface from the video, the electronic processor 140 generates and outputs a modified video in which the object and the first reflective surface have been redacted (at block 430).

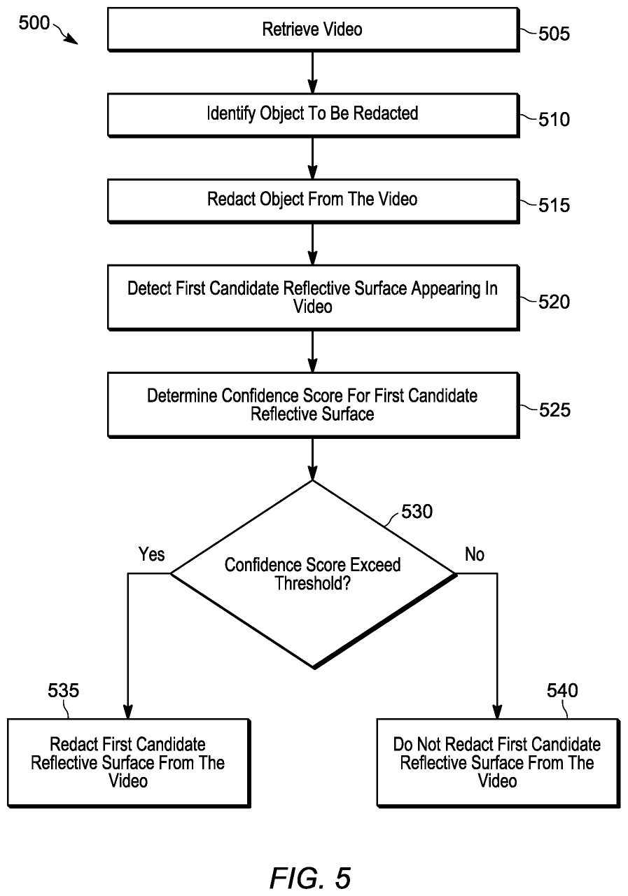

FIG. 5 illustrates a flowchart of a second example method 500 for redacting a video performed by one or more components, such as the video redactor 110 and/or the video camera 120, included in the video surveillance system 100. It should be understood that although a particular order of processing steps is indicated in FIG. 5 as an example, timing and ordering of such steps may vary where appropriate without negating the purpose and advantages of the examples set forth in detail throughout the disclosure. Furthermore, it should be some steps included in the method 500 are the same as or similar to steps included in the method 400, and thus the description of steps included in the method 400 is also applicable to steps in the method 500 that are the same or similar. For the sake of brevity, some examples described with respect to the steps included in the method 400 may not be repeated when describing the same or similar steps included in the method 500.

In the example illustrated, the method 500 begins with retrieving a video (at block 505). After retrieving the video, the electronic processor 140 identifies an object appearing in the video that is to be redacted (at block 510) and redacts the object from the video (at block 515). The method 500 further includes detecting, by the electronic processor 140, a first candidate reflective surface appearing in the video (at block 520).

After detecting the first candidate reflective surface, the electronic processor 140 determines a confidence score associated with the first candidate reflective surface (at block 525). As described above, a confidence score is a number that indicates how confident the video redaction application 200 executed by the electronic processor 140 is that a reflective surface reveals identifying information that should be redacted from the video. For example, the confidence score for a detected reflective surface indicates a likelihood of the detected reflective surface reflecting at least a portion of a redacted object, wherein the reflected portion of the redacted object risks revealing identifying information. When determining the confidence score of the first candidate reflective surface at block 525, the electronic processor 140 uses one or more of the computer vision and/or image processing techniques described herein to predict whether at least a portion of the object is reflected by the first candidate reflective surface. Moreover, when determining the confidence score of the first candidate reflective surface at block 525, the electronic processor 140 predicts the likelihood of identifying features of the object being revealed by the first candidate reflective surface if at least a portion of the object is reflected by the first candidate reflective surface.

At block 530, the electronic processor 140 compares the determined confidence score for the first candidate reflective surface to a confidence score threshold. As described above, the confidence score threshold is a user-configurable value that is used for determining whether to redact an object, object reflection, and/or a reflective surface from a video. If the confidence score determined at block 525 exceeds the confidence score threshold, the electronic processor 140 redacts the first candidate reflective surface from the video (at block 535). In contrast, the electronic processor 140 does not redact the first candidate reflective surface from the video if the confidence score determined at block 525 is less than the confidence score threshold (at block 540). In some examples, the electronic processor additionally prompts, via the user interface 170, a user to confirm whether the first candidate reflective surface should be redacted after comparing the determined confidence score to the confidence score threshold.

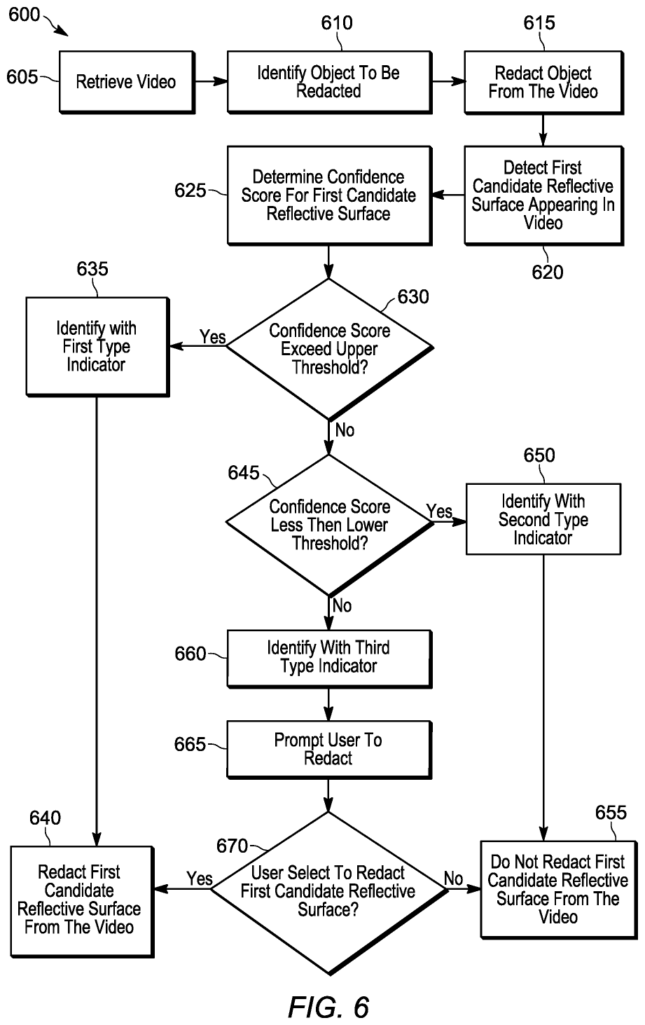

FIG. 6 illustrates a flowchart of a third example method 600 for redacting a video performed by one or more components, such as the video redactor 110 and/or the video camera 120, included in the video surveillance system 100. It should be understood that although a particular order of processing steps is indicated in FIG. 6 as an example, timing and ordering of such steps may vary where appropriate without negating the purpose and advantages of the examples set forth in detail throughout this disclosure. Furthermore, it should be some steps included in the method 600 are the same as or similar to steps included in methods 400 and/or 500, and thus the description of steps included in methods 400 and/or 500 is also applicable to steps in the method 600 that are the same or similar. For the sake of brevity, some examples described with respect to the steps included in methods 400 and/or 500 may not be repeated when describing the same or similar steps included in the method 600.

In the example illustrated, the method 600 begins with retrieving a video (at block 605). After retrieving the video, the electronic processor 140 identifies a object appearing in the video that is to be redacted (at block 610) and redacts the object from the video (at block 615). The method 600 further includes detecting, by the electronic processor 140, a first candidate reflective surface appearing in the video (at block 620) and determining, using the electronic processor 140, a confidence score for the first candidate reflective surface (at block 625).

At block 630, the electronic processor 140 compares the determined confidence score for the first candidate reflective surface to an upper confidence score threshold. If the confidence score determined at block 625 exceeds the upper confidence score threshold, the electronic processor 140 identifies the first candidate reflective surface with a first-type indicator and displays, using the user interface 170, a version of the video including the first-type indicator to a user (at block 635). As described above with respect to the illustrated example of FIG. 2, the first-type indicator is used to indicate to a user that the electronic processor 140 has determined to redact the first candidate reflective surface from the video. After identifying the first candidate reflective surface with the first-type indicator, the electronic processor 140 redacts the first candidate reflective surface from the video (at block 640).

If the confidence score determined at block 625 is less than the upper confidence score threshold, the electronic processor 140 determines whether confidence score is less than a lower confidence score threshold (at block 645). If the confidence score determined at block 625 is less than the lower confidence score threshold, the electronic processor 140 identifies the first candidate reflective surface with a second-type indicator and displays, using the user interface 170, a version of the video including the second-type indicator to a user (at block 650). As described above with respect to the illustrated example of FIG. 2, the second-type indicator is used to indicate to a user that the electronic processor 140 has determined to not redact the first candidate reflective surface from the video. After identifying the first candidate reflective surface with the second-type indicator, the electronic processor 140 does not redact the first candidate reflective surface from the video (at block 655).

If the confidence score determined at block 625 is greater than the lower confidence score threshold at block 645, the electronic processor 140 identifies the first candidate reflective surface with a third-type indicator and displays, using the user interface 170, a version of the video including the third-type indicator to a user (at block 660). As described above with respect to the illustrated example of FIG. 2, the third-type indicator is used to indicate to a user that the electronic processor 140 is not sure if the first candidate reflective surface should be redacted from the video. Accordingly, after identifying the first candidate reflective surface with the third-type indicator, the electronic processor 140 prompts the user, via the user interface 170, to select whether to redact the first candidate reflective surface from the video (at block 665). At block 670, the electronic processor 140 determines whether the user has selected to redact the first candidate reflective surface from the video. If the user selects to redact the first candidate reflective surface, the electronic processor 140 redacts the first candidate reflective surface from the video (at block 640). If the user selects to not redact the first candidate reflective surface, the electronic processor 140 redacts the first candidate reflective surface from the video (at block 655).

In the foregoing specification, specific examples, features, and aspects have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A video redactor comprising:
an electronic processor configured to:
retrieve a video;
identify an object to be redacted from the video;
redact the object from the video;
identify a first reflective surface appearing in the video;
redact the first reflective surface from the video; and
output a modified video in which the object and the first reflective surface have been redacted.

2. The video redactor of claim 1, wherein the first reflective surface appears in the video at at least substantially a same time at which the object appears in the video.

3. The video redactor of claim 1, wherein the object appears in the video during a first time period; and
wherein the first reflective surface appears in the video during a second time period, the second time period being different than the first time period.

4. The video redactor of claim 1, further comprising a user interface coupled to the electronic processor; and
wherein the electronic processor is further configured to:
identify a second reflective surface appearing in the video;
generate a symbol to identify the second reflective surface in the video;
prompt, via the user interface, a user to confirm whether the second reflective surface should be redacted from the video; and
redact the second reflective surface from the video in response to receiving, via the user interface, an input indicating the second reflective surface should be redacted from the video.

5. The video redactor of claim 1, wherein the electronic processor is further configured to:
determine whether at least a portion of the object is reflected by the first reflective surface;
redact the first reflective surface when at least a portion of the object is reflected by the first reflective surface; and
not redact the first reflective surface when no portion of the object is reflected by the first reflective surface.

6. The video redactor of claim 1, wherein the electronic processor is further configured to:
determine whether at least a portion of the object is reflected by the first reflective surface;
in response to determining that at least a portion of the object is reflected by the first reflective surface, determine whether the portion of the object reflected by the first reflective surface risks identifying the object;
redact the first reflective surface when the portion of the object reflected by the first reflective surface risks identifying the object; and
not redact the first reflective surface when the portion of the object reflected by the first reflective surface does not risk identifying the object.

7. The video redactor of claim 1, wherein the electronic processor is further configured to:
determine a confidence score for the first reflective surface, the confidence score indicative of a likelihood of the first reflective surface reflecting at least a portion of the object;
determine whether the confidence score exceeds a confidence threshold; and
redact the first reflective surface from the video when the confidence score exceeds the confidence threshold.

8. The video redactor of claim 1, wherein the electronic processor is further configured to:
identify an outline of the first reflective surface using an edge detection algorithm;
determine a planar normal of the first reflective surface based on the identified outline of the first reflective surface;
determine whether at least a portion of the object is reflected by the first reflective surface based on the planar normal of the first reflective surface and a field of view of a camera that recorded the video; and
redact the first reflective surface from the video in response to determining that at least a portion of the object is reflected by the first reflective surface.

9. The video redactor of claim 8, wherein the electronic processor is further configured to determine that at least a portion of the object is reflected by the first reflective surface when the object moves at at least substantially a same time at which movements occur within the outline of the first reflective surface.

10. The video redactor of claim 1, wherein the electronic processor is further configured to:
identify a plurality of reflective surfaces appearing in the video at substantially a same time at which the object appears in the video, the plurality of reflective surfaces including the first reflective surface;
determine whether any of the plurality of reflective surfaces reflect at least a portion of the object;
redact only a first subset of the plurality of reflective surfaces from the video when operating in a first redaction mode, the first subset including only the ones of the plurality of reflective surfaces that have been determined to reflect at least a portion of the object; and
redact all of the plurality of reflective surfaces from the video when operating in a second redaction mode regardless of whether the object is reflected by all of the plurality of reflective surfaces.

11. A method for video redaction comprising:
identifying, using the electronic processor, an object to be redacted from the video;
redacting, using the electronic processor, the object from the video; and
identifying, using the electronic processor, a first reflective surface appearing in the video;
redacting, using the electronic processor, the first reflective surface appearing in the video; and
outputting, using the electronic processor, a modified video in which the object and the first reflective surface have been redacted.

12. The method of claim 11, further comprising:
identifying, using the electronic processor, a second reflective surface appearing in the video;
generating, using the electronic processor, a symbol to identify the second reflective surface in the video;
prompting, via a user interface, a user to confirm whether the second reflective surface should be redacted from the video; and
redacting, using the electronic processor, the second reflective surface from the video in response to receiving, via the user interface, an input indicating the second reflective surface should be redacted from the video.

13. The method of claim 11, further comprising:
determining, using the electronic processor, whether at least a portion of the object is reflected by the first reflective surface; and
in response to determining that at least a portion of the object is reflected by the first reflective surface, determining, using the electronic processor, whether the portion of the object reflected by the first reflective surface risks identifying the object; and
redacting, using the electronic processor, the first reflective surface when the portion of the object reflected by the first reflective surface risks identifying the object.

14. The method of claim 11, further comprising:
determining, using the electronic processor, a confidence score for the first reflective surface, the confidence score indicative of a likelihood of the first reflective surface reflecting at least a portion of the object;
determining, using the electronic processor, whether the confidence score exceeds a confidence threshold; and
redacting, using the electronic processor, the first reflective surface from the video when the confidence score exceeds the confidence threshold.

15. The method of claim 11, further comprising:
identifying, using the electronic processor, an outline of the first reflective surface using an edge detection algorithm;
determining, using the electronic processor, a planar normal of the first reflective surface based on the identified outline of the first reflective surface;
determining, using the electronic processor, whether at least a portion of the object is reflected by the first reflective surface based on the planar normal of the first reflective surface and a field of view of a camera that recorded the video; and
redacting, using the electronic processor, the first reflective surface from the video in response to determining that at least a portion of the object is reflected by the first reflective surface.

16. A video surveillance system comprising:
a video camera configured to capture a video; and
a video redactor in communication with the video camera and including an electronic processor configured to:
retrieve the video;
identify an object to be redacted from the video;
redact the object from the video;
identify a first reflective surface appearing in the video;
redact the first reflective surface from the video; and
output a modified video in which the object and the first reflective surface have been redacted.

17. The video surveillance system of claim 16, wherein the video redactor further includes a user interface coupled to the electronic processor; and
wherein the electronic processor is further configured to:
identify a second reflective surface appearing in the video;
generate a symbol to identify the second reflective surface in the video;
prompt, via the user interface, a user to confirm whether the second reflective surface should be redacted from the video; and
redact the second reflective surface from the video in response to receiving, via the user interface, an input indicating the second reflective surface should be redacted from the video.

18. The video surveillance system of claim 16, wherein the electronic processor is further configured to:
determine whether at least a portion of the object is reflected by the first reflective surface;
redact the first reflective surface when at least a portion of the object is reflected by the first reflective surface; and
not redact the first reflective surface when no portion of the object is reflected by the first reflective surface.

19. The video surveillance system of claim 16, wherein the electronic processor is further configured to:
determine whether at least a portion of the object is reflected by the first reflective surface;
in response to determining that at least a portion of the object is reflected by the first reflective surface, determine whether the portion of the object reflected by the first reflective surface risks identifying the object;
redact the first reflective surface when the portion of the object reflected by the first reflective surface risks identifying the object; and
not redact the first reflective surface when the portion of the object reflected by the first reflective surface does not risk identifying the object.

20. The video surveillance system of claim 16, wherein the electronic processor is further configured to:
determine a confidence score for the first reflective surface, the confidence score indicative of a likelihood of the first reflective surface reflecting at least a portion of the object;
determine whether the confidence score exceeds a confidence threshold; and
redact the first reflective surface from the video when the confidence score exceeds the confidence threshold.
